(19) United States
(12) Patent Application Publication
(10) Pub. No.: US 2014/0135428 A1
(43) Pub. Date: May 15, 2014

(54) Polymerizate Comprising a Macromonomer

(71) Applicants: Heinz-Peter Klein, Mainz (DE); Bo Gao, Shanghai (CN); Peng Xu, Shanghai (CN); Michael Schottler, Bischofsheim (DE)

(72) Inventors: Heinz-Peter Klein, Mainz (DE); Bo Gao, Shanghai (CN); Peng Xu, Shanghai (CN); Michael Schottler, Bischofsheim (DE)

(73) Assignee: AKZO NOBEL CHEMICALS INTERNATIONAL B.V., Amersfoort (NL)

(21) Appl. No.: 14/126,909

(22) PCT Filed: Jun. 19, 2012
(86) PCT No.: PCT/EP2012/061626

§ 371 Date: Dec. 17, 2013

Related U.S. Application Data
(60) Provisional application No. 61/501,978, filed on Jun. 28, 2011.

(30) Foreign Application Priority Data
Jun. 22, 2011 (EP) 11171025.7

(51) Int. Cl. C08L 29/04; C04B 24/26

(52) U.S. Cl. CPC C08L 29/04; C04B 24/2623
USPC 524/5; 524/503; 525/58; 524/27

(57) ABSTRACT

The present invention relates to a polymerizate in the form of an aqueous polymer dispersion, the polymerizate being obtainable by radical polymerization of monomers in an aqueous medium in the presence of a free radical initiator and a protective colloid, wherein the monomers comprise a) 50-99.99 wt. % of at least one vinyl monomer chosen from the group of vinyl esters, (meth)acrylic esters, vinyl aromatic compounds, vinyl halides, and olefins, and b) 0.01-30 wt. % of at least one macromonomer M, the macromonomer M being a reaction product of components (i), (ii), and (iii), said —component (i) having at least one olefinically unsaturated group and at least one hydroxyl, amine and/or thiol group, —component (ii) being a di- or triisocyanate, and —component (iii) having at least two terminal groups selected from hydroxyl, amine and/or thiol groups, c) 0-20 wt % of at least one vinyl monomer with at least one functional group, wherein the monomers a), b), and c) sum up to 100 wt. % of total monomers employed. The invention further provides a process to prepare the polymerizate, water-redispersible polymer powders obtainable from the polymerizate, and building material compositions containing the polymerizate and/or the water-redispersible polymer powders.

The present invention relates to a polymerizate in the form of an aqueous polymer dispersion or water-redispersible polymer powder that comprises a macromonomer comprising urethane, urea and/or thiocarbamate groups, to a process to prepare the dispersion or polymer powder, and to the use thereof in building material compositions.

Aqueous polymer dispersions, also called polymer dispersions in the context of this invention, and water-redispersible polymer powders, also called polymer powders in the context of this invention, are commonly used as additives in building material compositions to improve their performance, e.g. with respect to adhesion, cohesion, and flexibility of the cured building material composition.

The use of cement as inorganic binder in building material compositions increases in particular the cohesion of the hardened building material composition upon hydration and curing. Therefore, cement is a very common and preferred raw material—and in combination with polymer dispersions or polymer powders can be formulated into building material compositions to provide many superior properties.

When polymer powders are used in e.g. cement-based formulations, dry, one-component mortars can be formulated which only need to be mixed with water at the building site just before their application. Such dry mortars have many well-known advantages, such as e.g. freeze-thaw stability, and due to the absence of water, less weight needs to be transported.

Nowadays, the market requires more and more building material compositions with which applications with more demanding properties, e.g. water-impermeable products with long-lasting water resistance, can be achieved. One example is described in the Guideline for European Technical Approval of Watertight covering kits for wet room floors and or walls, as outlined in ETAG 022 Part 1: Liquid applied coverings with or without wearing surface, Edition 2007-04-11. This guideline covers watertight covering kits for interior wet room floors and/or walls. These liquid applied covering products, including pasty materials, become watertight coverings upon curing and/or drying. They are placed on the surface of a substrate, followed by curing and placing another layer onto the thus obtained watertight coverings. Thus, the liquid applied covering becomes the inner surface of the wet floor or wall, e.g. the layer beneath the floor screed, wall render or underneath ceramic tiles, which serves as wearing surface. In order to fulfill the requirements of the guideline, the cured building material compositions need to pass e.g. the following requirements, which depend on different substrates and performance categories:
High water tightness, determined according to EN14891,
Good to excellent crack bridging ability, determined according to EN1062-7, and to fulfill different assessment categories for cracks up to 0.4 mm, 0.75 mm and up to 1.5 mm,
Good bond or adhesion strength, determined according to EN14891 from 0.3 N/mm² and up to 0.5 N/mm² on various substrates.

In order to formulate building material compositions which fulfill these demanding requirements, the polymer load needs to be fairly high, e.g. up to about 75 wt. % of the total dry weight of the composition. Thus, it becomes obvious that the performance of the polymer plays an essential role.

However, one drawback of hydrated and cured polymer-modified, cement-based products is embrittlement under the influence of water due to post-hydration of the cement, especially under dry and wet cycles. This causes the bond to the ceramic tile being damaged, which may lead finally to delamination of the tile. And the higher the polymer content, the more pronounced is also this effect. Hence, the durability of such products is significantly reduced.

A solution to overcome this problem can be seen in cement-free systems, in particular in systems which are essentially free of mineral binders. They are available on the market as pasty formulations based on surfactant-stabilized dispersions. Although still commonly used, they have many disadvantages, including limited freeze-thaw stability due to the presence of water, the addition of biocides to improve shelf life, and the disposal of the empty containers.

These disadvantages are mitigated or overcome by formulating dry, cement-free systems using polymer powders. However, such formulations as known today cannot match the performance of pasty formulations. Surfactant-stabilized dispersions used in pasty systems easily film-form upon drying. Therefore, when surfactant-stabilized dispersions are used in attempting to make water-redispersible polymer powders, these dispersions will readily film-form to lead to products which are not at all water-redispersible. Protective colloid-stabilized dispersions, on the other hand, show a lower tendency of film formation. Therefore, protective colloid-stabilized dispersions are preferred for making water-redispersible polymer powders. Hence, film formation can be strongly reduced or even avoided when such dispersions are processed to polymer powders, and they keep their ability to redisperse. The reduced degree of film formation of protective colloid-stabilized dispersions and polymer powders obtained therefrom is less relevant in cement-based compositions. However, in cement-free systems in particular under wet conditions they are known to show a lower level of tensile strength compared to surfactant-stabilized dispersions.

Therefore, it is the object of the present invention to provide water-redispersible polymer powders with which essentially cement-free, dry building material compositions with improved properties, in particular with an increased level of tensile strength under wet conditions, can be formulated. These compositions are easily miscible with water and can be applied on a great variety of surfaces.

It has surprisingly been found that the problem can be solved with a polymerizate in the form of an aqueous polymer dispersion, wherein polymerizate is obtainable by radical polymerization of monomers in an aqueous medium in the presence of a free radical initiator and a protective colloid, wherein the monomers comprise
a) 50-99.99 wt. % of at least one vinyl monomer chosen from the group of vinyl esters, (meth)acrylic esters, vinyl aromatic compounds, vinyl halides, and olefins, and
b) 0.01-30 wt. % of at least one macromonomer M, the macromonomer M being a reaction product of components (i), (ii) and (iii), said
   component (i) having at least one olefinically unsaturated group and at least one hydroxyl, amine and/or thiol group,
   component (ii) being a di- or triisocyanate, and
   component (iii) having at least two terminal groups selected from hydroxyl, amine and/or thiol groups,
c) 0-20 wt % of at least one vinyl monomer with at least one functional group selected from the group of alkoxysilane, silanol, glycidyl, epoxy, epihalohydrin, nitrile, carboxyl, amine, ammonium, amide, imide, N-methylol, isocyanate, hydroxyl, thiol, keto, carbonyl, carboxylic anhydride, sulfonic acid groups, and salts thereof, and monomers having one or more further vinyl groups,
wherein the monomers a), b) and c) sum up to 100 wt. % of total monomers employed.

Also claimed are water-redispersible polymer powders, also called polymer powders in the context of the invention, obtained by drying the polymerizate of the present invention.

It was surprisingly found that the polymerizate—in the form of an aqueous dispersion or a redispersion obtained by redispersing the polymer powder in water—forms a film having a significantly increased tensile strength, in particular when obtained polymer films were stored under wet conditions, i.e. when immersed in water. The fact that the polymerizates of the invention with copolymerized macromonomer M lead to films with an enhanced tensile strength compared to films from polymerizates without the macromonomer is even more surprising since it is understood that film formation is increased by a higher mobility of the polymer chains inside a dispersion or latex particle, while the use of the macromonomer M having 2 or more unsaturated vinyl groups leads to crosslinked polymer chains—and thus much bulkier polymer—inside the latex particles. Thus, as a matter of fact, the finding of the invention is against the general perception of the skilled person in the art, who would actually expect the opposite effect, namely a reduction of the tensile strength under wet conditions.

The polymer powders of the invention can surprisingly be manufactured in an efficient manner in good yield. No special care is required with respect to film formation when producing the polymer powders. Hence, the polymer powders of the invention show a similar low film formation tendency in the powder state, but after redispersion they demonstrate a superior film formation which leads to the increased tensile strength under wet conditions. The polymer powders redisperse readily upon contact with water to the primary particle size of the dispersion used to make the polymer powder. The polymer powder properties, in particular the free-flowing characteristics, the anti-caking properties, powder storage properties, the compatibility with other powdery products/components, and the wettability upon contact with water, can well be compared to those of standard commercial polymer powders, while the film formation of the polymer powder redispersed in water is superior to such polymer powders. Additionally, the film-formation capability of the redispersion is even comparable to that of the dispersion used to form the polymer powder. Thus, no adverse effects are introduced upon making the polymer powder.

Additionally, it was a surprise to find that with the polymer powders of the invention it is possible to formulate products in the form of dry uncured building material compositions which, after being applied and cured, perform as well as pasty products based on surfactant-stabilized dispersions.

Fundamental characteristics of such liquid-applied, water-impermeable products are:
Initial tensile adhesion strength
Tensile strength under different conditions (after water contact, after heat ageing, after freeze-thaw cycles, after contact with lime water, and after contact with chlorinated water)
Waterproofing (no water penetration through the underside of the specimen at a water pressure of 150 kPa for 7 days)
Crack bridging ability (ability of hardened waterproofing material to withstand propagation of the cracks without deterioration at different temperatures).

Claimed also is a kit of parts suitable for use in building applications, one part being the water-redispersible polymer powder of the invention and the other part being one or more powdery additives. The latter are preferably selected from the group of hydrophobic and/or oleophobic additives, rheology control additives, thickeners, polysaccharides and derivatives thereof, additives to control the hydration and/or setting, surface-active additives, pigments, fibers, film coalescing agents and plasticizers, corrosion protection additives, pH-adjusting additives, additives for the reduction of shrinkage and/or efflorescence. The term kit of parts is understood to be a mixture comprising the one part and another part.

The polymer powder of the invention is surprisingly well compatible with many different additives used e.g. to formulate building material compositions. With these kits of parts it is possible to add another functional feature to the powder. Thus, the kit of parts of the invention provides, besides the water-redispersible polymer powder with increased tensile strength of the film, one or more additional functional features, such as an optimized rheology of the uncured, water-mixed building material composition, or an increased hydrophobicity, increased adhesion and/or water resistance, reduced tendency of efflorescence and/or corrosion of the cured building material composition.

The invention further provides a process of making the polymerizate of the invention by means of emulsion or suspension polymerization even without any particular emulsification technique such as membrane emulsification or high shear equipment to produce e.g. mini-emulsions. The products obtained therefrom are emulsions or dispersions. These terms are interchangeable and include also the products obtained from suspension polymerization.

The fact that the macromonomer contains olefinically unsaturated bonds allows easy copolymerization of said macromonomers with essentially no grit formation. There is no need to add specific functional monomers to enable reaction with the macromonomer. There is also no need to add a specific catalyst to boost such a reaction. Simple addition of a radical initiator—which is added for emulsion polymerization purposes anyway—is sufficient.

Furthermore, it was unexpected to find that the macromonomer M has a good compatibility with both the monomers, i.e. when the macromonomer M is in non-polymerized form, and the emulsion polymerizate containing the copolymerized macromonomer M.

Especially in cases where olefinically unsaturated monomers become larger and therefore bulkier and/or monomers having no or only a very low water-solubility, a skilled person would be much more tempted to make use of the miniemulsion technology where the monomers are emulsified completely in a first step to result in a miniemulsion. Besides a surfactant also a co-surfactant is used, such as e.g. hexadecane or cetyl alcohol. The subsequent polymerization occurs inside the formed miniemulsion droplets, which avoids grit formation. Thus, miniemulsion polymerization is a complex process requiring a multi-step procedure with special, high-shear equipment for making a miniemulsion. Furthermore, the polymerization mechanism is distinctly different from the one in emulsion or suspension polymerization, where the monomers have to diffuse from a large monomer drop through the aqueous medium into the emulsion or suspension droplet.

Macromolecules 2005, 38, 4183-4192 describes the “Preparation of Polyurethane/Acrylic Hybrid Nanoparticles via a Miniemulsion Polymerization Process”. Thus, a nanosized polyurethane/poly(n-butyl methacrylate) hybrid latex was prepared by first mixing a polyurethane macromonomer, an acrylic monomer, surfactants, and a costabilizer, such as hexadecane, to obtain a stable miniemulsion, followed by polymerization of the obtained miniemulsion. The solids of the obtained miniemulsion are as low as about 20 wt. % and the mean particle size is about 50 nm. The polyurethane macromonomer was used in amounts of 25, 50 and 75 wt. %. The use of stabilization colloids, such as water-soluble polymers, and water-redispersible polymer powders obtained therefrom, is not disclosed.

JP-A-2006206740 discloses an aqueous adhesive agent composition comprising a urethane-modified acrylic resin-based emulsion A and an acrylic resin-based emulsion B, wherein emulsion A is obtained by mini-emulsion polymerization using acrylic monomers, a cross-linkable unsaturated monomer, a urethane resin, and a tackifier. The miniemulsion A is stabilized using surfactants. The type of urethane resin is not specified and the use of protective colloids is not mentioned.

US-A-2005/0228144 discloses resin particles which include a polymer of monomers containing a urethane compound and an acrylic acid ester. The resin particles are formed by introducing a treatment liquid containing a monomer with pressure into a medium liquid via a porous membrane to form a droplet of treatment liquid in the medium liquid and to harden the treatment liquid composing the droplet by heating said liquid. The particles are stabilized with small amounts of surfactants and protective colloid, e.g. polyvinyl alcohol, which may be not less than 0.3 pbw, but not more than 1.0 pbw per 100 pbw of medium liquid. The resin particles are used as core material in conductive particles, which themselves are part of an anisotropic conductive adhesive. Macromonomers according to the present invention are not disclosed and the position is silent about any use in construction materials.

Hence, it was even more surprising to find that macromonomers M, which have a low water solubility and which—for monomers suitable for radical emulsion polymerization—may have high molecular weights such as about 5,000 or even higher, can easily be copolymerized even in a high concentration by aqueous emulsion and suspension polymerization using water-soluble polymers, i.e. protective colloids, as stabilizers and without the need to use a co-surfactant.

Thus, it is very advantageous that the polymerizates of the invention can be made using common and well established polymerization processes such as emulsion and suspension polymerization at high solids and with low particle sizes. Hence, there is no need for complex procedures or equipment, such as high-shear mixing equipment or membrane emulsification technique. Furthermore, it is possible with the process of the invention to produce the polymerizates of the invention without the need for costabilizers, which are volatile organic compounds (VOC) and thus highly unwanted materials which may cause problems during the drying of the polymerizates to make the water-redispersible polymer powders. Additionally, such VOCs are increasingly banned as ingredients in building material compositions.

The invention also relates to the use of the polymerizate, the water-redispersible polymer powder, a kit of parts containing said polymer powder as an additive in building material compositions, as well as to the building material composition containing the polymerizate, the water-redispersible polymer powder, the kit of parts containing the polymer powder, and at least one mineral binder or filler.

It was surprisingly found that the polymer powder of the invention can be used to formulate dry building material compositions, even compositions free of mineral binders, which impart an increased tensile strength after wet storage, and thus increased cohesion of the composition, compared with state-of-the-art polymer powders. Additionally, the adhesion, in particular after wet storage, to substrates is improved. Thus, dry building material compositions can be formulated to match the more demanding properties for special applications like e.g. cement-free membranes, also called cement-free sealants, for use beneath ceramic tiling. Furthermore, the polymerizate of the invention can also be used to formulate e.g. pasty, cement-free building material compositions, which may even be free of any mineral binder.

Due to the presence of the polymerizate or polymer powder of the invention, building material compositions can be formulated which have a good compatibility with other ingredients without essential limitations to the formulator. Furthermore, the dry building material compositions of the invention show a good wettability and miscibility upon addition of or to water. Hence, with these building material compositions it is even possible to fulfill the demanding requirements of EN 14891:2007/AC2009. This standard applies to all liquid-applied water-impermeable products based on polymer-modified cementitious mortars, dispersions as well as reaction resin coatings, used as watertight coverings beneath ceramic tiling, for internal and external tile installations on walls and floors. Therefore, it is possible to replace polymer-modified cementitious, liquid-applied water-impermeable products with building material compositions which are essentially free of a mineral binder, in particular free of cement, containing the polymerizate of the invention in the form of an aqueous dispersion or polymer powder.

### The Polymerizate

The polymerizate of the invention is in the form of an aqueous polymer dispersion, wherein the polymerizate is obtainable by radical polymerization of monomers in an aqueous medium in the presence of a free radical initiator and a water-soluble polymer, i.e. protective colloid, wherein the monomers comprise a) at least one vinyl monomer, b) at least one macromonomer M, and optionally at least one vinyl monomer c) with at least one functional group. The radical polymerization is preferably an emulsion or suspension polymerization.

In a preferred embodiment, the polymerizate, i.e. the aqueous polymer dispersion, has a solid content of about 30 to 70 wt. %, preferably of about 40 to 60 wt. %, and a Brookfield viscosity, measured at 23° C. and 20 rpm according to DIN 53019, of about 100 to 30,000 mPa·s, preferably about 500 to 20,000 mPa·s. The mean particle size is about from 0.1 μm, preferably from about 0.2 μm, to about 20.0 μm, preferably to about 10.0 μm and in particular to about 4.0 μm, with it also being possible that the dispersion has smaller and/or larger emulsion particles. A preferred particle size range of the aqueous polymer dispersion is from about 0.1 μm to about 4.0 μm and in particular from about 0.2 μm to about 2.5 μm. The particle size is measured by means of light scattering (for small particles, e.g. below 1 μm) or light diffraction (for larger particles, e.g. above 1 μm), such as e.g. ISO 13320:2009, and indicated as volumetric mean. These techniques are well known to the skilled person.

In another preferred embodiment, the polymerizates and polymer powder of the invention preferably have a content of volatile organic compounds (VOC) of less than about 2,000 ppm, preferably of less than about 1,000 ppm, in particular of less than about 500 ppm, based on the solid content of the polymerizate or dry content of the polymer powder. In the context of the invention, the VOCs are determined in accordance with the Directive of the European Union 2004/42/CE, which classifies as VOC each organic compound which at a standard pressure of 101.3 kPa has a boiling point of 250° C. or lower. When the VOC-content prior to drying is too high, it can be reduced using common techniques such as for instance vapour and/or vacuum distillation and/or reacting off residual monomers. Such techniques are known to the skilled person.

The monomer selection and the selection of the weight fractions of the comonomers are made so that in general the resulting glass transition temperature of the polymerizate, Tg, is between −50° C. and +50° C., preferably between −30° C. and +40° C. The glass transition temperature, Tg, of the polymers can be determined in a known manner by means of differential scanning calorimetry (DSC), in which case the midpoint temperature in accordance with ASTM D3418-82 has to be taken into account. The Tg can also be calculated approximately in advance using the Fox equation.

According to T. G. Fox, Bull. Am. Physics Soc. 1, 3, page 123 (1956): 1/Tg=x₁/Tg₁+x₂/Tg₂+ . . . +xₙ/Tgₙ, where xₙ represents the mass fraction (% by weight/100) of the monomer n and Tgₙ is the glass transition temperature, in Kelvin, of the homopolymer of the monomer n. Tg values for homopolymers are listed in e.g. Ullmann's Encyclopedia of Industrial Chemistry, VCH, Weinheim, Vol. A21 (1992), p. 169.

In yet another preferred embodiment, it is advantageous that the polymerizate of the invention has a minimum film formation temperature of below room temperature, typically at or below 20° C., more preferably at or below 10° C., and in particular at or below 5° C., wherein the MFFT is determined in accordance with DIN 53787.

### The Vinyl Monomer a)

At least one vinyl monomer a) is chosen from the group of vinyl esters, (meth)acrylic esters, vinyl aromatic compounds, vinyl halides and olefins in an amount of 50-99.99 wt. %, preferably of 65-99.95 wt. %, and in particular of 75-99.9 wt. %, based on the sum of total monomers a), b), and c) employed. The vinyl monomer a) is different to the vinyl monomer c).

Suitable vinyl esters are one or more monomers from the group of vinyl esters of branched or unbranched carboxylic acids having 1 to 20 carbon atoms.

Preferred vinyl esters are vinyl acetate, vinyl propionate, vinyl butyrate, vinyl 2-ethylhexanoate, vinyl laurate, 1-methylvinyl acetate, vinyl pivalate, vinyl versatate having 9, 10 or 11 carbons (VeoVa™ 9/10/11), vinyl decanoate, vinyl stearate, vinyl pyrrolidone. Vinyl acetate and VeoVa™ 9/10/11 are particularly preferred.

Furthermore, it is also possible to copolymerize vinyl monomers derived from biomonomers. Suitable biomonomers are disclosed in EP-A-2 702 544, EP-A-2 075 322, EP-A-2 075 322, and PCT/EP2011/057374; the contents thereof are incorporated herein by reference. Non-limiting examples include biomonomers containing an ester of a polyol and at least one fatty acid, the polyol having 2 to 10 hydroxy groups, and the biomonomer containing at least one vinyl group. They are preferably used in an amount of about 0.5-80 wt. %, in particular based on the total amount of vinyl monomer a).

Suitable (meth)acrylic ester monomers are the linear, cyclic or branched C₁- to C₂₀-alkyl esters. Preferred C₁- to C₁₂-alkyl groups of (meth-)acrylic acid esters are methyl, ethyl, propyl, n-butyl, i-butyl, t-butyl, hexyl, cyclohexyl, 2-ethylhexyl, lauryl, stearyl, norbornyl, polyalkylene oxide and/or polyalkylene glycol groups, in particular methyl, butyl, 2-ethylhexyl groups. Preferred methacrylic esters or acrylic esters are methyl acrylate, methyl methacrylate, ethyl acrylate, ethyl methacrylate, propyl acrylate, propyl methacrylate, n-butyl acrylate, i-butyl acrylate, n-butyl methacrylate, i-butyl methacrylate, 2-ethylhexyl acrylate, (5-ethyl-1,3-dioxan-5-yl) methyl (meth)acrylate, ethyldiglycol(meth)acrylate, stearyl acrylate, stearyl methacrylate, and norbornyl acrylate. Methyl methacrylate, n-butyl acrylate, 2-ethylhexyl acrylate, stearyl (meth)acrylate, and norbornyl acrylate are particularly preferred.

From the group of vinyl aromatic compounds styrene, styrene derivatives, such as α-methyl styrene, ortho-chloro styrene or vinyl toluene, vinyl pyridine, as well as vinyl esters of benzoic acid and p-tert-butylbenzoic acid are preferred, with styrene being particularly preferred.

From the group of vinyl halides, it is common to use vinyl chloride, though vinylidene chloride is also an option.

From the group of olefins ethylene, propylene, isoprene, and butadiene are typically used.

### The Macromonomer M

It is possible to use one type of macromonomer M or two or more different types of macromonomer M. It is used in an amount of 0.01-30 wt. %, preferably of 0.05-15 wt. %, in particular of 0.1-5 wt. %, and most preferably of 0.1-4 wt. %, based on the sum of total monomers a), b), and c) employed. It contains one or more ethylenically unsaturated groups. In a preferred embodiment, at least 50 wt. %, in particular at least 75 wt. %, of the macromonomer M contains two ethylenically unsaturated groups.

In many cases it is advantageous when the macromonomer M has a number average molecular weight in the range of 300 to 50,000, preferably in the range of 400 to 30,000, in particular in the range of 500 to 20,000.

Furthermore, it is often preferred when the macromonomer M is non-ionic and thus does not contain groups that can be protonated, such as e.g. amino groups, and/or deprotonated, such as e.g. carboxyl groups.

In a particularly preferred embodiment, at least 50 wt. %, in particular at least 75 wt. %, of the macromonomer M has the formula (I)

A-B-(C-B-)ₓA (I)

wherein A originates from component (i), B originates from component (ii), C originates from component (iii), and A and C are linked with B through a urethane or carbamate (O—C(═O)—N), urea (N—C(═O)—N) and/or a thiocarbamate group (S—C(═O)—N), and x is an integer of 1 to 200, preferably an integer of 1 to 100, and in particular an integer of 1 to 50.

The macromonomer M is a reaction product of components (i), (ii), and (iii). Component (i) has at least one olefinically unsaturated group and at least one hydroxyl, amine and/or thiol group, and is preferably a vinyl monomer containing a hydroxy, amino and/or thio group. Component (ii) is a di- or triisocyanate, preferably a diisocyanate, and component (iii) has at least two terminal groups selected from hydroxyl, amine and/or thiol groups, preferably a diol, diamine, dithiol, polyol, polyamine, polythiol, polyhydroxy polyolefin, a polyester, polyether, polycarbonate, polyamide or a polyalkylene oxide having terminal hydroxyl, amine and/or thiol groups, with the alkylene group being an ethylene, propylene and/or butylene group.

Upon the reaction of component (ii), which comprises two or three isocyanate groups, with components (i) and (iii), which both comprise a hydroxyl, amine and/or thiol group, the resultant macromonomer M comprises urethane, urea and/or thiocarbamate groups. In a preferred embodiment, the macromonomer M comprises urethane groups and thus can be considered a polyurethane macromonomer.

The macromonomer M is preferably obtainable by first reacting component (iii) with component (ii), followed by reaction with component (i). Thus, in a preferred embodiment the macromonomer M is obtainable by two reaction steps. One way of making a macromonomer M is described in Macromolecules 2005, 38, 4183-4192.

Exemplary, non-limiting structures of the macromonomer M include formulae (II) to (V), wherein in each formula n may be e.g. between 1 and 200:

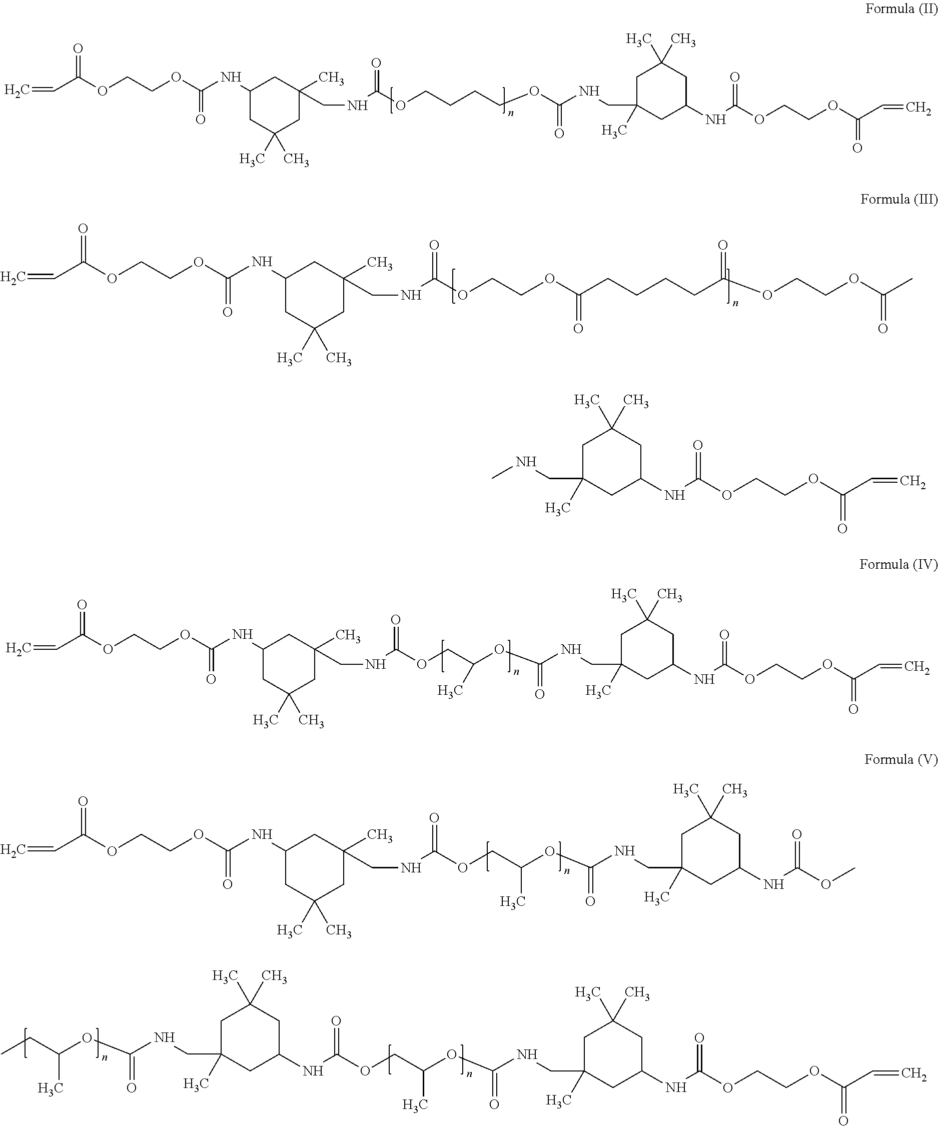

Since the macromonomer M contains one or more ethylenically unsaturated groups, i.e. vinyl groups, it easily copolymerizes with the vinyl monomers a) and, if present, with the vinyl monomers c), during the radical polymerization of monomers in the aqueous medium in the presence of a free radical initiator and a stabilizer such as a water-soluble polymer.

Commercially available macromonomers M can be obtained from e.g. RAHN AG, Zürich, Switzerland (Genomer-types) and Sartomer Europe, Paris La Defense Cedex, France (CN-types). Preferred grades include Genomer™ 4205, Genomer™ 4215/M22, Genomer™ 4217, Genomer™ 4302, Genomer™ 4312, Genomer™ 4316, as well as Sartomer's CN966H90, CN975, CN9002, CN9170A86, CN9178, CN9788, CN9893, and Ebecryl™ 230, Ebecryl® 244, Ebecryl® 264, Ebecryl™ 265, Ebecryl™ 270 and Ebecryl™ 284 from Cytec.

They are designed and offered for UV and electron beam curing monomers and thus are cured after being applied onto a substrate. In these types of applications unlike in aqueous dispersions obtained by emulsion polymerization, no particles are formed. Hence, so far it has been unknown to use these types of monomers in emulsion polymerization.

Component (i) of the macromonomer M contains an ethylenically unsaturated group, such as a vinyl group, and at least one group which is reactive towards an isocyanate, such as a hydroxyl, amino or mercapto, i.e. thiol group.

Non-limiting examples of suitable vinyl group-containing compounds are hydroxylalkyl esters of α,β-unsaturated carboxylic acids, e.g. hydroxyethyl (meth)acrylate, hydroxypropyl (meth)acrylate), hydroxybutyl (methacrylate), amino-containing (meth)acrylates, e.g. t-butylaminoethyl(meth)acrylate, 2-aminoethyl(meth)acrylate and 2-aminoethyl(meth)acrylate hydrochloride, vinyl pyridines, aziridine ethyl(meth)acrylate, methylaminopropyl(meth)acrylate, morpholinoethyl(meth)acrylate, 1,2,2,6,6-pentamethylpiperidinyl(meth)acrylate, aminopropyl vinyl ether, ethylaminopropyl ether, alkylamino group-containing vinyl ethers and/or esters, alkylamino groups-containing (meth)acrylates and/or (meth)acrylamides or reaction products of monoepoxy compounds and α,β-unsaturated carboxylic acids, and reaction products of α,β-unsaturated glycidyl esters or ethers with monocarboxylic acids.

Component (ii) of macromonomer M is a di- or triisocyanate, preferably a diisocyanate, which also includes urethane-modified polyisocyanate based on a diisocyanate.

Non-limiting examples of suitable isocyanates include alkylene diisocyanates, cycloalkylene diisocyanates, aromatic diisocyanates, and aliphatic-aromatic diisocyanates. Specific examples of suitable isocyanate-containing compounds include, but are not limited to, ethylene diisocyanate, ethylidene diisocyanate, 2,3-dimethylethylene diisocyanate, propylene diisocyanate, butylene diisocyanate, trimethylene diisocyanate, 1-methyltrimethylene diisocyanate, penta-methylene diisocyanate, 1,5 diisocyanato-2-methylpentane, hexamethylene diisocyanate, 1,12-diisocyanatododecane, 1-isocyanatomethyl-5-isocyanato-1,3,3-trimethylcyclohexane, bis(4-isocyanatocyclohexyl)methane, 2,2-bis(4-isocyanatocyclohexyl)propane, 2,3-bis(8-isocyanatooctyl)-4-octyl-5-hexylcyclo-hexene, toluene diisocyanate and/or its trimer, cyclopentylene-1,3-diisocyanate, cyclo-hexylene-1,4-diisocyanate, cyclohexylene-1,2-diisocyanate, 4,4′-diphenyl-methane diisocyanate, 2,4′-diphenylmethane diisocyanate, 2,2-diphenyl-propane-4,4′-diisocyanate, 4,4′-diisocyanatodiphenyl ether, xylylene diisocyanate, tetramethylxylylene diisocyanates, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenyl-sulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triiso-cyanato-toluene, 4,4′-dimethyldiphenyl-methane-2,2′,5,5-tetratetraisocyanate, and the like. As such compounds are commercially available, methods for synthesizing them are well known in the art. In addition, the various isomers of α,α,α′,α′-tetramethyl xylene diisocyanate can be used. Useful aromatic isocyanates include the various isomers of toluene diisocyanate such as 2,4-toluene diisocyanate, 2,6-toluene diisocyanate and/or mixtures of 2,4- and 2,6-toluene diisocyanate and/or its trimer, meta-xylenediioscyanate and para-xylenediisocyanate, 4-chloro-1,3-phenylene diisocyanate, 1,5-tetrahydro-naphthalene diisocyanate, 4,4′-dibenzyl diisocyanate, and 1,2,4-benzene triisocyanate, naphthalene-1,5-diisocyanate, 1-methoxyphenyl-2,4-diisocyanate, 4,4′-diphenylmethane diisocyanate (MDI), 2,4′-diphenylmethane diisocyanate, mixtures of 4,4′-diphenyl diisocyanate, 3,3′-dimethyl-4,4′-diphenyl diisocyanate, 3,3′-dimethyl-4,4′-diphenyl diisocyanate, and 3,3′-dimethyldiphenyl methane-4,4′-diisocyanate. Useful aliphatic polyisocyanates include aliphatic diisocyanates such as ethylene diisocyanate, 1,2-diisocyanatopropane, 1,3-diisocyanatopropane, 1,6-diisocyanatohexane, 1,4-butylene diisocyanate, lysine diisocyanate, hexamethylene diisocyanate (HDI), uretidinedione of HDI (dimer), biurets of HDI (trimer), Isocyanurate of HDI (trimer), HDI diisocyanurate adduct (two isocyanurate rings together), HDI isocyanurate-uretidinedione adduct, isophorone diisocyanate (IPDI), isocyanurate of IPDI (trimer), 1,4-methylene bis-(cyclohexyl isocyanate). Suitable polymeric polyisocyanates are for instance cycloaliphatic and/or aromatic polyisocyanates and/or polymethylene polyphenylene polyisocyanates (polymeric MDI). Included among the usable isocyanates are those modifications containing carbodiimide, allophanate, urethane, biuret, or isocyanurate structures. Unmodified polymeric MDI and mixtures of polymeric MDI and pure 2,4- and 4,4′-MDI and carbodiimide-modified MDI are preferred. These polyisocyanates are prepared by conventional methods known in the art, e.g. phosgenation of the corresponding organic amine. Particularly preferred are methylenebis(phenyldiisocyanate) (MDI; 2,4′-MDI, 4,4′-MDI, and polymeric MDI), isophorone diisocyanate (IPDI) and/or its trimer, toluene diisocyanate (TDI) and/or its trimer, phenyl isocyanate, hydrogenated 4,4′-methylenebis(phenylisocyanate) (HMDI) and/or hexanediisocyanate and/or its trimer and/or tetramethylxylylene diisocyanate.

Component (iii) of macromonomer M has at least two terminal groups selected from hydroxyl, amine and/or thiol groups, preferably a diol, diamine, dithiol, polyol, polyamine, polythiol, polyhydroxy polyolefin and/or a polyester, polyether, polycarbonate, polyamide, and polyalkylene oxide having terminal hydroxyl, amine and/or thiol groups, with the alkyl group being an ethylene, propylene and/or butylene group.

A wide range of different amines can be used, with primary and/or secondary amines being preferred. If a monoamine is used, it is helpful when the compound further contains at least another group with a heteroatom, such as a hydroxyl and/or thiol group, which may react with an isocyanate group.

Mono-functional amines generally have the structure R₁R₂NH, where R₁ and R₂ are independently H or C₁ to C₂₂ alkyl; C₆ to C₂₈ aryl, or C₆ to C₂₈ aralkyl, with R₁ and/or R₂ preferably containing at least one hydroxyl, carboxylic acid, amine and/or thiol group.

Preferred mono-functional amines include amines having a low skin irritation if left unreacted in the formulation, such as 2-amino-2-methylpropanol or higher alkyl primary and secondary amines as well primary and secondary alkanolamines. Other examples of suitable linear diamines include the Jeffamine™ range such as the polyoxypropylene diamines available as Jeffamine™ D230, Jeffamine™ D400, and Jeffamine™ D2000, as well as Jeffamine™ EDR-148, a triethylene glycol diamine from Huntsman Corporation, Salt Lake City, Utah, USA. Examples of alkyl-substituted branched diamines include 2 methyl-1,5 pentane diamine, 2,2,4 trimethyl-1,6 hexane diamine, and 2,4,4 trimethyl-1,6 hexane diamine. Cyclic diamines may also be used, such as isophorone diamine, cyclohexane diamine, piperazine, and 4,4′-methylene bis(cyclohexyl amine), 4,4′-2,4′ and 2,2′-diaminodiphenylmethane, 2,2,4 trimethyl-1,6 hexane diamine, 2,4,4 trimethyl-1,6 hexane diamine and polyoxypropylene diamines. Alkanolamines are compounds containing amine moieties and hydroxyl moieties. Suitable examples of alkanolamines include 2-(methyl amino) ethanol, N-methyldiethanolamine, trialkanolamine, triethanolamine, triisopropanolamine, and the like. Suitable examples of compounds containing an amino group and a further group selected from amino and hydroxy include diamines, alkanolamines, and amine-terminated polyamides or polyethers. Mixtures of such compounds can also be used. Useful polyfunctional amines include tris(2-aminoethyl)amine and amine-terminated polyethers. Furthermore, primary and/or secondary amines, such as aliphatic amines (e.g. 1,2-diaminoethane), oligomers of 1,2-diaminoethane (for example, diethylenetriamine, triethylenetetramine or pentaethylenehexamine). Particularly preferred amines include dialkanolamine such as diethanolamine, N-(2-aminoalkyl)dialkanolamine, such as N-(2-aminoethyl)diethanolamine and/or N-(2-aminoethyl)dibutylamine, and cyclic structures such as 1-(2-aminoethyl)piperazine.

A wide range of different compounds having one or more hydroxyl groups, i.e. alcohols, can be used, with dialcohols, i.e. glycols, being preferred. If a monoalcohol is used, it is helpful when the compound further contains at least another group with a heteroatom, such as an amine and/or thiol group, which may react with an isocyanate group.

Preferred hydroxyl containing compounds include diethylene glycol, dipropylene glycol, trimethylene glycol, triethylene glycol, 1,1,1-trimethylol propane, 1,1,1-trimethylol ethane, 1,2,6-hexane triol, o-methyl glucoside, pentaerythritol, sorbitol, and sucrose, fructose, glucose or any other sugar alcohol, triethanolamine, diethylene glycol, dipropylene glycol, triethylene glycol, tripropylene glycol, glycerol, trimethylol propane, polyhydric alcohols having from 2 to 15 carbon atoms with two or more hydroxyl groups. Examples of suitable polyhydric alcohols include glycerol, pentaerythritol, trimethylol propane, 1,4,6-octanetriol, glycerol monoallyl ether, glycerol monoethyl ether, 2-ethylhexanediol-1,4, cyclohexanediol-1,4,1,2,6-hexanetriol, 1,3,5-hexanetriol, 1,3-bis-(2-hydroxyethoxy)propane, and the like. It is also possible to use polyols such as polyhydroxy ethers (substituted or unsubstituted polyalkylene ether glycols or polyhydroxy polyalkylene ethers), polyhydroxy polyesters, polyhydroxy polyethers, polyhydroxy polycarbonates, polyhydroxy olefins, and polyhydroxy polyester amides, with the diols of such compounds being most preferred, the ethylene or propylene oxide adducts of polyols and the monosubstituted esters of glycerol, as well as mixtures thereof. Examples of polyether polyols include a linear and/or branched polyether having plural numbers of ether bondings and at least two hydroxyl groups, and contain substantially no functional group other than the hydroxyl groups. Examples of the polyether polyol may include polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct of at least one compound selected from the group consisting of ethylene glycol, propylene glycol, diethylene glycol, triethylene glycol, dipropylene glycol, triethylene glycol, 2-ethylhexanediol-1,3,glycerin, 1,2,6-hexane triol, trimethylol propane, trimethylol ethane, tris(hydroxyl-phenyl)propane, triethanolamine, triisopropanolamine, ethylenediamine, and ethanolamine; with at least one compound selected from the group consisting of ethylene oxide, propylene oxide, and butylene oxide. Suitable polyoxy-ethylene/polyoxpropylene copolymers and polyoxypropylene adducts are polyether polyols having a functionality of at least two. Preferred alcohols include trialkanolamine, such as triethanolamine, dialkylalkanolamine, such as dialkylethanolamine and/or dibutylethanolamine, 4-(2-hydroxyethyl)morpholine, diethylene glycol, triethylene glycol, and/or bis(O,O′-2-aminoethyl)ethylene-glycol, glycerol, and derivatives, trimethylol propane and alkoxylated derivatives, pentaerythritol and alkoxylated derivatives, dipentaerythritol and alkoxylated derivatives, tripentaerythritol and alkoxylated derivatives 1,4,6-octanetriol, 1,2,6-hexanetriol, sucrose, glucose, fructose, polyether triols, propoxylated ethylene diamine, propoxylated diethylene triamine and/or Mannich polyols.

Suitable polyhydroxypolyesters are generally prepared by esterification of polycarboxylic acids or their anhydrides with organic polyhydroxy compounds. Suitable polyhydroxy compounds are alkylene glycols such as glycol, 1,2-propanediol, 1,3-propanediol, 1,4-butanediol, neopentyl glycol, hexane-1,6-diol, diethylene glycol, triethylene glycol, cyclohexanedimethanol, 2,2-bis(4′-hydroxycyclohexyl)propane, and polyhydric alcohols like trishydroxyalkylalkanes (e.g. trimethylol propane) or tetrakishydroxyalkylalkane (e.g. pentaerythrol). Suitable polycarboxylic acids having from 2 to 18 carbon atoms are e.g. succinic acid, adipic acid, azelaic acid, sebacic acid, maleic acid, glutaric acid, triemelitic acid, pyromellitic acid, tetrahydrophthalic acid, hexahydrophthalic acid, phthalic acid, isophthalic acid, terephthalic acid, dimeric and trimeric fatty acids and anhydrides of such compounds where these exist. Other polyhydroxy polyesters are derived from polylactones, which are obtainable by reacting lactones, e.g. ε-caprolactone, with polyols.

Non-limiting examples of polyethers, which include polyhydroxypolyethers, are e.g. polyethylene glycols, polypropylene glycols, copolymers thereof, and polytetramethylene glycols.

Suitable polycarbonates, which include polyhydroxypolycarbonates, can be prepared by reaction of polyols such as 1,3-propanediol, 1,4-butanediol, neopentyl glycol, hexane-1,6-diol, diethylene glycol, triethylene glycol, cyclohexanedimethanol, trimethylol propane, and pentaerythrol with phosgene or dicarbonates such as dimethyl, diethyl or diphenyl carbonate.

Suitable polyhydroxypolyester amides can be derived e.g. from polycarboxylic acids and polyhydroxy compounds—as mentioned—and aminoalcohols as a mixture with polyhydroxy compounds. Non-limiting examples of amino alcohols include ethanolamine and monoisopropanolamine.

Suitable polyhydroxy polyolefins can be derived e.g. from oligomeric or polymeric olefins preferably having at least two terminal hydroxyl groups, e.g. a, ω-dihydroxypolybutadiene.

A wide range of different thiols or mercaptans can be used. If a monothiol is used, it is helpful when the compound further contains at least another group with a heteroatom, such as an amine and/or hydroxyl group, which may react with an isocyanate group.

Non-limiting examples include aliphatic thiols such as alkane, alkene, and alkyne thiols having at least two or more —SH groups, such as polythiols such as 2,2′-oxytris(ethane thiol).

Furthermore, it is also possible to use silicone polyols and/or polyamines and/or perfluoroalkyl functional polyols, trimethylol propane tris(3-mercaptopropionate), pentaerythritol tetrakis(3-mercaptopropionate), dipentaerythritol hexakis-(thioglycolate), tripentaerythritol octakis(thioglycolate).

### The Vinyl Monomer c)

Besides the vinyl monomer a) and the macromonomer M (b) it is possible to add optionally one or more vinyl monomers c). Said vinyl monomer c) has at least one functional group in addition to the vinyl group. Thus, the vinyl monomer c) differs from vinyl monomer a). The vinyl monomer c) can be added in an amount of 0-20 wt. %, preferably of 0-10 wt. %, and in particular of 0-5 wt. %, based on the sum of total monomers a), b), and c). The functional group of vinyl monomer c) is selected from the group of alkoxysilane, silanol, glycidyl, epoxy, epihalohydrin, nitrile, carboxyl, amine, ammonium, amide, imide, N-methylol, isocyanate, hydroxyl, thiol, keto, carbonyl, carboxylic anhydride, sulfonic acid groups, and salts thereof. As a consequence thereof, the vinyl monomer a) does not contain such a functional group.

Non-limiting examples of suitable vinyl monomers c) having an amide and/or a methylol group include (meth)acrylamide and (meth)acrylamide with N-substituted linear, cyclic or branched C₁- to C₂₀-alkyl groups, preferably C₁- to C₁₂-alkyl groups, being methyl, ethyl, propyl, n-butyl, i-butyl, t-butyl, hexyl, cyclohexyl, 2-ethylhexyl, lauryl, stearyl, norbornyl, polyalkylene oxide and/or polyalkylene glycol groups, in particular methyl, butyl, 2-ethylhexyl groups. Furthermore, suitable vinyl monomers having an amide group include N-vinyl formamide and/or N-vinyl acetamide, N-methylolacrylamide and N-methylol (meth)acrylamide, methylacrylamido glycolic acid and alkyl ester thereof, esters of N-methylol (meth)acrylamide and of N-methylolallyl carbamate, as well as methylacrylamido glycolic acid methylester and ethylenically unsaturated carboxamides.

Non-limiting examples of suitable vinyl monomers c) having a carboxyl and/or carboxylic anhydride group include monocarboxylic and dicarboxylic acids and their anhydrides, preferably acrylic acid, methacrylic acid, itaconic acid, crotonic acid, fumaric acid, maleic acid, maleic anhydride, and acrylamidoglycolic acid. When monomers with carboxyl groups are used, it is advantageous when this portion is small, e.g. 5 wt. % or lower, in particular 2 wt. % or lower, and preferably 1 wt. % or lower, based on the total of monomers a), b), and c).

Non-limiting examples of suitable vinyl monomers c) having a hydroxyl group include hydroxyalkyl esters of α,β-unsaturated carboxylic acids, e.g. hydroxyethyl (meth)acrylate, hydroxypropyl (meth)acrylate), hydroxybutyl (methacrylate), reaction products of monoepoxy compounds and α,β-unsaturated carboxylic acids, as well as reaction products of α,β-unsaturated glycidyl esters or ethers with monocarboxylic acids.

Non-limiting examples of suitable vinyl monomers c) having an amino group include amino-containing (meth)acrylates and amino-containing (meth)acryl-amides, e.g. t-butylaminoethyl(meth)acrylate, 2-aminoethyl(meth)acrylate, and 2-aminoethyl(meth)acrylate hydrochloride, methylaminopropyl(meth)acrylate, aminopropyl vinyl ether, alkylamino group-containing vinyl ethers and/or esters such as (di)ethylaminopropyl vinyl ether, alkylamino groups-containing (meth)acrylates and/or (meth)acrylamides, N-[3-(dimethylamino)propyl] (meth)-acrylamide, N-[3-(dimethylamino)ethyl](meth)acrylate, t-butylaminoethyl(meth)-acrylate, dimethylaminopropyl(meth)acrylate, aziridine ethyl(meth)acrylate, morpholinoethyl(meth)acrylate, 1,2,2,6,6-pentamethylpiperidinyl(meth)acrylate, 1,2,2,6,6-pentamethylpiperidinyl(meth)acrylate and/or morpholinoethyl(meth)-acrylate.

Non-limiting examples of suitable vinyl monomers c) having an ammonium group include cationic monomers such as N,N-[(3-chloro-2-hydroxypropyl)-3-dimethylammonium propyl]-(meth)acrylamide chloride, N-[3-dimethylamino)-propyl]-(meth)acrylamide hydrochloride, N-[3-(trimethylammonium)propyl]-(meth)acrylamide chloride, (3-chloro-2-hydroxypropyl)dimethyl[3-(2-methyl-1-oxoallyl)amino]propyl)ammonium chloride, 2-hydroxy-3-(meth)acryloxypropyl-trimethyl ammonium chloride, dimethyldiallyl ammonium chloride, trimethyl ammoniumethyl(meth)acrylate chloride, N-[3-(trimethylammonium)propyl]-(meth)acrylamide chloride and/or N,N-[3-chloro-2-hydroxypropyl)-3-dimethyl-ammonium-propyl](meth)acrylamide chloride. Furthermore, the cationic charge can be prepared either through protonation of amines, in which case it is easily removable in an alkaline medium, or it can for instance be formed through quaternization of the amine group of amino group-containing monomers.

Non-limiting examples of suitable vinyl monomers c) having an epoxy or an epihalohydrin group, which may form an epoxy group in alkaline medium, include glycidyl (meth)acrylate, and (3-chloro-2-hydroxypropyl)dimethyl[3-(2-methyl-1-oxoallyl)amino]propyl)ammonium chloride.

Non-limiting examples of suitable vinyl monomers c) having an alkoxysilane group include (meth)acryloxypropyl trialkoxy silane, vinyltrialkoxy silane, and vinylmethyldialkoxy silane, with the alkoxy groups being preferably methoxy, ethoxy and/or iso-propoxy groups. The alkoxy group may also be partially hydrolyzed to the silanol group.

Non-limiting examples of suitable vinyl monomers c) having a carbonyl such as an aldehyde and/or keto group include acetoacetoxyethyl(meth)acrylate (AAEA and AAEMA), acetoacetonate vinyl esters and/or diacetone acrylamide. It is noted that the carbonyl group is not an ester or carboxyl group.

Non-limiting examples of suitable vinyl monomers c) having a sulfonic acid group include ethylenically unsaturated sulfonic acids and their salts, preferably vinylsulfonic acid and 2-acrylamido-2-methylpropane sulfonic acid, styrene sulfonic acid, acrylic acid-sulfopropyl ester, itaconic acid-sulfopropyl ester, as well as in each case the ammonium, sodium, potassium and/or calcium salts.

Non-limiting examples of suitable vinyl monomers c) having a nitrile group include carbonitriles and acrylonitrile.

A non-limiting example of a suitable vinyl monomer c) having an isocyanate group is α,α-dimethyl-m-propenyl benzylisocyanate (tradename: TMI® from Cytec).

Non-limiting examples of suitable vinyl monomers c) having a further vinyl group include polyfunctional compounds such as multiple ethylenically unsaturated monomers, e.g. butanediol di(meth)acrylate, hexanediol di(meth)acrylate, trimethylol propane tri(meth)acrylate, allyl (meth)acrylate and/or tripropylene-glycol di(meth)acrylate.

The Water-Soluble Polymer, i.e. Protective Colloid

The polymerizate of the invention contains a water-soluble polymer, i.e. protective colloid, which acts as stabilizer to stabilize the aqueous polymer dispersion obtained upon the radical polymerization of the monomers. It is possible to use one or more water-soluble polymers as stabilizer. Furthermore, it is also possible to employ only water-soluble polymer or to use as stabilizer a mixture of water-soluble polymers and surfactants. The latter are also called emulsifiers.

In a preferred embodiment, the stabilizer comprises 50 to 100 wt. % of protective colloid and 0 to 50 wt. % of emulsifier, even more preferably 75 to 100 wt. % of protective colloid and 0 to 25 wt. % of emulsifier, in particular 90 to 100 wt. % of protective colloid and 0 to 10 wt. % of emulsifier, and most preferably 95 to 100 wt. % of protective colloid and 0 to 5 wt. % of emulsifier.

It is noted that in the context of this invention, the water-soluble polymer is added before and/or during the polymerization in order to act as stabilizer. The term protective colloid is used in this invention as synonym for the terms water-soluble colloid and water-soluble polymer.

In one embodiment, the amount of stabilizer, based on the sum of monomers employed, used during radical polymerization is about 2 to 20 wt. %, preferably about 3 to 15 wt. %, and in particular about 4 to 12 wt. %.

In another embodiment, the amount of stabilizer used during radical polymerization is, based on the total amount of aqueous polymer dispersion, about >1.0 to 15 wt. %, preferably about 1.5 to 12 wt. %, and in particular about 2 to 10 wt. $.

When the polymerizate is further processed to obtain a water-redispersible polymer powder, it is often advantageous when the total amount of stabilizer comprises at least 75 wt. %, preferably at least 90 wt. %, and in particular 100 wt. %, of one or more water-soluble polymers.

Water-soluble polymers, i.e. protective colloids, for use in emulsion polymerization are well known to the person skilled in the art. The stabilizer can in addition contain one partially water-soluble or water-insoluble ionic colloid prepared according to for instance EP 1 098 916, EP 1 109 838, EP 1 102 793, and EP 1 923 405. In addition, it is also possible to use additionally or as protective colloid one or several natural or synthetic polymers which are only soluble in the alkaline pH-range, which means that at least about 50 wt. %, preferably at least about 70 wt. %, in particular about 90 wt. %, will dissolve in water with a pH-value of 10 as a 10 wt. % solution at 23° C. Non-limiting examples of these are poly(meth)acrylic acids and the copolymers thereof.

Representative synthetic protective colloids of the invention which can be used are for example one or several polyvinyl pyrrolidones and/or polyvinyl acetals with a molecular weight of 2,000 to 400,000, fully or partially saponified polyvinyl alcohols and the derivatives thereof, which can be modified for instance with amino groups, acetoacetoxy groups, carboxylic acid groups and/or alkyl groups, with a degree of hydrolysis of preferably about 70 to 100 mol. %, in particular of about 80 to 98 mol. %, and a Höppler viscosity in 4% aqueous solution of preferably 1 to 100 mPa·s, in particular of about 3 to 50 mPa·s (measured at 20° C. in accordance with DIN 53015), as well as melamine formaldehyde sulfonates, naphthaline formaldehyde sulfonates, polymerizates of propylene oxide and/or ethylene oxide, including also the copolymerizates and block copolymerizates thereof, styrene-maleic acid and/or vinyl ether-maleic acid copolymerizates.

Preferred synthetic protective colloids are partially saponified, optionally modified polyvinyl alcohols with a degree of hydrolysis of 80 to 98 mol. % and a Höppler viscosity as 4% aqueous solution of 1 to 50 mPa·s and/or polyvinyl pyrrolidone.

In a further embodiment, natural and/or synthetically prepared protective colloids can be chosen from the group of biopolymers such as polysaccharides and polysaccharide ethers, for instance cellulose ethers such as hydroxyalkyl-cellulose and/or alkyl-hydroxyalkyl-cellulose, in which case the alkyl group may be the same or different and preferably is a C₁- to C₆-group, in particular a methyl, ethyl, n-propyl and/or i-propyl group, carboxymethyl cellulose, starch and starch ethers (amylose and/or amylopectine and/or the derivatives thereof), guar ethers, dextrins, agar-agar, gum arabic, carob seed grain, pectin, gum tragacanth and/or alginates. Often it is advantageous when these are soluble in cold and/or alkaline water. The polysaccharides can, but do not need to be, chemically modified, for instance with carboxymethyl, carboxyethyl, hydroxyethyl, hydroxypropyl, methyl, ethyl, propyl, sulfate, phosphate and/or long-chain alkyl groups. As synthetic polysaccharides can be used for instance anionic, non-ionic or cationic heteropolysaccharides, in particular xanthan gum, welan gum and/or diutan gum. Preferred peptides and/or proteins to be used are for instance gelatin, casein and/or soy protein.

Preferred biopolymers are dextrins, cellulose ethers, carboxymethyl cellulose, starch, starch ethers, casein, soy-protein, gelatin, as well as hydroxyalkyl-cellulose and/or alkyl-hydroxyalkyl-cellulose, in which case the alkyl group may be the same or different and preferably is a C₁- to C₆-group, in particular a methyl, ethyl, n-propyl and/or i-propyl group.

If surfactants are used, they can have a nonionic, anionic, cationic or zwitterionic nature and mixtures thereof can be used. Suitable surfactants are well known to the skilled person in the art.

During the radical polymerization process, the stabilizer can either be included completely in the initial charge or, alternatively, be included partly in the initial charge and partly metered in. In yet another embodiment, the stabilizer, or a portion of it, can be mixed first with the monomer to form a pre-emulsion, which then can be metered in as such.

Preferably, at least 5% by weight, most preferably at least 20 wt. % of the water-soluble polymer is included in the initial charge.

### Process to Make the Polymerizate

The polymerizate is obtained by the radical polymerization of monomers in an aqueous medium. Preferably, the preparation takes place by the emulsion or suspension polymerization process. In a preferred embodiment, the polymerizate is obtained without any specific emulsification technique such as membrane emulsification or high shear equipment.

During the polymerization process the polymerization temperature is in one embodiment suitably from 40° C. to 140° C., preferably from 60° C. to 100° C. In embodiments where gaseous comonomers such as ethylene or vinyl chloride are copolymerized, it is also possible to operate under pressure, generally between 5 bar and 120 bar.

The polymerization is carried out in the presence of one or more free radical initiators, i.e. one or more water-soluble or monomer-soluble initiators, or redox initiator combinations, which are customary for emulsion polymerization and suspension polymerization, respectively.

The group of suitable initiators includes thermal initiator systems, such as persulfates, for instance potassium, sodium and/or ammonium persulfate, water- and monomer-soluble azoinitiators, such as azobisisobutyronitrile, azobiscyanovaleric acid, as well as 2,2′-azobis(2-methylpropionamidine)-dihydrochloride, redox-initiator systems consisting of oxidising agents, such as for instance hydrogen peroxide, t-butyl hydroperoxide, t-butyl peroxide, isopropylbenzene monohydroperoxide, cumene hydroperoxide, t-butyl peroxopivalate, dibenzoyl peroxide, bicyclohexyl peroxydicarbonate and/or dicetyl peroxydicarbonate, and reducing agents, such as for instance sodium, potassium, ammonium, sulfite and/or disulfite, sodium, potassium and/or zinc formaldehyde sulfoxylate, primary, secondary and/or tertiary amines with a molecular weight of preferably less than 1,000, such as tetraethylene pentamine as well as ascorbic acid and/or iso-ascorbic acid, with it being possible, if so desired, to use oxidizing agents which can form free radicals by means of thermal decomposition as such, as well as catalytic initiator systems, such as for instance the system H₂O₂/Fe⁺²/H⁺. The content of initiators, based on the monomer content, preferably is between about 0.01 and 5 wt. %, in particular between about 0.1 and 3 wt. %.

Preferred oxidizing agents are peroxides such as hydrogen peroxide or organic peroxides such as t-butyl hydroperoxide and/or peroxyacetic acid, persulfates such as ammonium, sodium and/or potassium persulfate, percarbonates such as sodium and/or potassium percarbonate, borates such as for instance sodium and/or potassium borate, transition metals with high oxidation numbers such as for instance permanganates and/or dichromates, metal ions such as for instance Ce⁺⁴, Ag⁺, Cu⁺², anions of halogen oxo-acids such as for instance bromates, halogens such as for instance chlorine, fluorine, bromine and/or iodine, hypochlorites such as for instance sodium and/or potassium hypochlorite and/or ozone.

In order to control the molecular weight it is possible to use regulating substances, also called chain transfer agents, during the polymerization. If regulators are used, they are normally used in amounts of from 0.01 to 5.0 wt. %, based on the monomers to be polymerized, and they are metered in separately or else as a premix with reaction components. Examples of such substances are n-dodecyl mercaptan, tert-dodecyl mercaptan, mercapto-propionic acid, methylmercaptopropionate, isopropanol, and acetaldehyde.

In one preferred embodiment, in the process to make the polymerizate by means of emulsion or suspension polymerization, at least 50 wt. %, preferably at least 75 wt. %, and in particular 100 wt. %, of the macromonomer M, based on the total amount of macromonomer M employed, is mixed with the vinyl monomers a) and c) to form a monomer blend which is added as such to the reactor either before the start of the polymerization and/or during the polymerization. The remainder of the macromonomer M can be added in the form of a preemulsion and/or as a separate monomer feed before the start of the polymerization and/or during the polymerization.

In another preferred embodiment, at least 50 wt. %, preferably at least 75 wt. %, and in particular 100 wt. %, of the macromonomer M, based on the total amount of macromonomer M employed, is mixed with the vinyl monomers a) and c), water, and the water-soluble polymer to form a preemulsion, with said preemulsion being added to the reactor, wherein the monomer blend and/or the preemulsion are added before the start of the polymerization and/or during the polymerization. The remainder of the macromonomer M can be added in the form of a monomer blend and/or as a separate monomer feed before the start of the polymerization and/or during the polymerization.

### Process to Make the Polymer Powder

In this specification the term water-redispersible polymer powder stands for a powder wherein the primary particles from the polymerizate are designed in such a manner that they keep their shape after they are dried, optionally with suitable adjuvants. This means that drying can be done while avoiding film formation. Thus, upon being mixed with water, the polymer powder redisperses back to the primary particle size. The water-redispersible polymer powder is obtainable by drying the polymerizate of the invention.

In one embodiment to make polymer powders, the glass transition temperature of the polymerizate is not too low, since otherwise, despite the use of added stabilizing colloids, coalescence and thus film formation will occur when making the polymer powders, which has a distinct detrimental effect on redispersion. Thus it has been shown that the glass transition temperature for polymerizates in the form of redispersible polymer powders as a rule should not be lower than −30° C., preferably not lower than −25° C., and most preferably not lower than about −20° C., in order to obtain a polymer powder which is still readily redispersible in water, which can also be transported without any problem, and which can even be stored at +50° C.

In order to prepare the water-redispersible polymer powders, the aqueous dispersions are admixed if desired with spraying aids and optionally further additives followed by drying. The total amount of spraying aid prior to the drying operation ranges in many cases from at least 3 to 30% by weight, based on the polymer fraction, and it is preferred to use from 5 to 20% by weight based on the polymer fraction.

Suitable spraying aids are partially hydrolyzed polyvinyl alcohols; polyvinylpyrrolidones; polysaccharides in water-soluble form such as starches (amylose and amylopectin), celluloses and their carboxymethyl, alkyl, hydroxyalkyl, and alkylhydroxyalkyl derivatives, with the alkyl group preferably being a methyl, ethyl and/or propyl group and the hydroxyalkyl preferably being a hydroxyethyl and/or hydroxypropyl group; proteins such as casein or caseinate, soya protein, gelatin; lignin sulfonates, synthetic polymers such as poly(meth)acrylic acid, copolymers of (meth)acrylates with carboxyl-functional comonomer units, poly(meth)acrylamide, polyvinylsulfonic acids and their water-soluble copolymers; melamine formaldehyde sulfonates, naphthalene-formaldehyde sulfonates, and styrene-maleic acid and vinyl ether-maleic acid copolymers. It is noted that these types of materials may also be added, e.g. additionally, during or after the drying step.

Preferably, partially hydrolyzed polyvinyl alcohols and polysaccharides such as cellulose ethers, starches and dextrins are used as spraying aids.

At the spraying stage it has in many cases been found advantageous to include up to 2 wt. % of antifoam, based on the base polymer.

The drying to obtain the polymer powder of the invention can take place, optionally after the addition of further water-soluble polymers and/or further additives, by means which avoid or at least minimize film formation of the emulsion. Preferred such means are spray drying, including pulse combustion spray drying, freeze drying, fluidized bed drying, drum drying or flash drying, in which case spray drying is particularly preferred and the spraying can take place for instance by means of a spraying wheel such as rotating disc, one-component or multi-component nozzle. If necessary, the mixture to be dried can still be diluted with water, in order to achieve a suitable viscosity for the drying. The drying temperature in principle has no real limits. In particular because of safety-related considerations, however, it should not, as a rule, exceed about 200° C., in particular about 175° C. In order to attain sufficiently efficient drying, temperatures of the inlet air of about 110° C. or higher, in particular of about 120° C. or higher, are preferred. The exit temperature is generally chosen in the range from 45° C. to 120° C., preferably from 60° C. to 100° C.

In order to extend storage life by improving the blocking stability, especially in the case of polymer powders having a low glass transition temperature, the polymer powder obtained can be provided with an antiblocking (anticaking) agent, preferably up to 50% by weight, based on the overall weight of polymeric constituents. These anticacking agents can be added before, during and/or after the drying step. Non-limiting examples of antiblocking agents include Ca and/or Mg carbonate, talc, gypsum, silica, kaolins, silicates, and latent hydraulic binders such as pozzolanes, metakaolin, burnt shale, diatomeous earth, moler, rice husk ash, air cooled slag, calcium metasilicate and/or volcanic slag, volcanic tuff, trass, fly ash, silica fume, fumed silica, microsilica, blast-furnace slag, and/or silica dust. They have preferably a particle size in the range from 10 nm to 100 microns, preferably 50 nm to 50 microns.

The mean particle size of the polymer powder after drying in one embodiment amounts to at least about 10 μm or more, preferably about 30 μm or more, in particular about 50 μm or more. In addition, it is often useful when the mean particle size is at most about 2 mm or less, preferably about 1 mm or less, in particular about 0.5 mm or less, and the polymer powder is easily pourable as well as block and storage stable. The particle size of the polymer powder particles is preferably measured by means of light scattering, in which case the volumetric mean is also decisive.

In a preferred embodiment, the water-redispersible polymer powder of the invention contains about 30 to 100 wt. %, preferably about 50 to 95 wt. %, in particular about 60 to 85 wt. %, of at least one water-insoluble, synthetic polymer, i.e. the polymerizate of the invention, about 2 to 50 wt. %, preferably about 3 to 30 wt. %, in particular about 5 to 20 wt. %, of at least one water-soluble polymer as stabilizer, about 2 to 50 wt. %, preferably about 5 to 40 wt. %, in particular about 10 to 30 wt. %, of at least one filler and/or anti-caking agent, as well as optionally further additives, with the specifications in wt. % being based on the total weight of the polymer powder composition and summing up to 100 wt. %.

The optional further additives of the water-redispersible polymer powder of the invention can be added before, during and/or after the drying step. Preferred are plasticizers, preservative agents such as biocides, herbicides, algicides and/or fungicides, anti-foaming agents, anti-oxidants, preservatives such as preservatives against oxidation, heat, ozone, light, fatigue and/or hydrolysis, additives for the reduction of sedimentation and/or bleeding, surface-active compounds such as wetting agents, anti-foaming agents and/or tensides.

The water-redispersible polymer powder of the invention can further be mixed with one or more additives to obtain a kit of parts suitable for use in building applications, one part being the water-redispersible polymer powder of the invention and the other part one or more powdery additives.

The powdery additives are preferably selected from the group of hydrophobic and/or oleophobic additives, rheology control additives, thickeners, polysaccharides and derivatives thereof, additives to control the hydration and/or setting, surface-active additives, pigments, fibers, film coalescing agents and plasticizers, corrosion protection additives, pH-adjusting additives, additives for the reduction of shrinkage and/or efflorescence.

The skilled person in the art is well aware of these types of powdery additives and is able to make the best choice regarding type and amount. However, to avoid any misunderstanding, hydrophobic additives are understood to be components which render the building material composition hydrophobic and thus repel water. Furthermore, they often reduce the water absorption capacity of the building material composition. Preferred are paraffins, organosilanes such as alkyl alkoxy silanes, the alkyl group being preferably a C₁ to C₄ alkyl group and the alkoxy group being preferably a C₁ to C₄ alkoxy group, siloxanes, silicones, metal soaps, fatty acids and/or fatty acid esters, a rosin or a rosin derivative which might containing a resin.

Oleophobic additives are typically based on fluorine compounds and thus reduce the dirt pick-up of building material compositions containing the same. Such compositions are also known to have “easy-to-clean” properties.

Rheology control additives include, besides thickeners, casein, superplasticizers, in particular polycarboxylates, melamine formaldehyde condensates, and naphthaline formaldehyde condensates.

Thickeners include polysaccharide ethers, in particular cellulose and guar ethers substituted with alkyl and/or hydroxyalkyl groups, in particular with the alkyl group being a methyl, ethyl and/or propyl group and the hydroxyalkyl group being a hydroxyethyl and/or hydroxypropyl group, starches, dextrins, modified or unmodified, fully or partially hydrolyzed polyvinyl alcohols, polyalkylene oxides, agar-agar, carob seed grains, pectins, poly(meth)acrylates and/or (meth)acrylate thickeners, poly(meth)acrylamides, polyurethanes, associative thickeners, inorganic thickeners, e.g. layered silica, gelatine, peptides and/or soy protein.

Additives to control the hydration and/or setting of minerally setting systems include setting accelerators, solidification accelerators and/or setting retarders.

Surface-active additives include air-entraining agents, foam stabilizers, defoamers, polyalkylene oxides and polyalkylene glycols, with the alkylene group typically being a C₂- and/or C₃-group and including their copolymerizates and block copolymerizates.

Furthermore, pigments, fibers, e.g. cellulose fibers, film coalescing agents and plasticizers, corrosion protection additives, pH-adjusting additives having an acidic or alkaline reaction with water, in particular oxides and/or hydroxides of alkali and/or alkaline earth salts, additives for the reduction of shrinkage and/or efflorescence such as for instance compounds based on natural resins, in particular colophony and/or the derivatives thereof, as well as quaternary organic ammonium compounds may be added.

The weight ratio of the water-redispersible polymer powder to the other part of the kit of parts, i.e. one or more powdery additives, can be adjusted according to the individual need and may range from 1:100 to 100:1, preferably from 1:10 to 10:1.

### The Building Material Composition

In one preferred embodiment, the polymerizate of the invention is used in building material compositions which contain no or less than 5 wt. % mineral binder, preferably less than 3 wt. %, with the mineral binder being preferably cement and/or gypsum. In another embodiment, the building material composition contains just a small amount of a hydraulic binder, e.g. cement, or a mineral binder, e.g. calcium hydroxide, to adjust the pH value of the building material composition when mixed with water. The pH value is preferably adjusted to a pH range of 8 to 13, in particular to a pH range of 10 to 12.

In another preferred embodiment, the polymerizate of the invention is used in building material compositions which are based on one or more mineral binders. Mineral binders are—in the meaning of the invention—understood to be binders which as a rule are in powder form and in particular consist of at least a) one hydraulically setting binder, b) one latent hydraulic binder and/or c) one non-hydraulic binder which reacts under the influence of air and water.

As hydraulically setting binders can be used cement, in particular Ordinary Portland Cement, for instance in accordance with EN 196 CEM I, II, Ill, IV, and V, high-alumina cement and/or gypsum, by which are meant in the meaning of this invention in particular calcium sulfate in the form of α- and/or β-semihydrate and/or anhydrite of form I, II and/or III. As latent hydraulic binders pozzolanes such as metakaolin, calcium metasilicate and/or volcanic slag, volcanic tuff, trass, fly ash, acid blast-furnace slag and/or silica dust can be used, which react hydraulically in combination with a calcium source such as calcium hydroxide and/or cement. As non-hydraulic binder can be used in particular lime, mostly in the form of calcium hydroxide and/or calcium oxide. Preferred above all are pure Portland cement-based construction material compounds, a mixture of Portland cement, high-alumina cement, and calcium sulfate, as well as gypsum-based building compositions, with it being possible in each case, if so desired, to also add latent hydraulic and/or non-hydraulic binders.

In another preferred embodiment, the building material composition is in the form of a dry uncured composition and contains the polymerizate in the form of a water-redispersible polymer powder.

Due to the high tensile strength under wet conditions of the polymer powder of the invention, such dry uncured compositions can be used in outdoor as well as indoor applications.

Building material compositions—in the form of a dry, pasty, two or multi-component mortar—can be formulated as a coating or composite material used for thermal insulation (ETICS), sealing applications, flexible water-proofing membranes, plasters, renders, repair mortar, tile grouts, adhesives, e.g. ceramic tile adhesives (CTA), parquet adhesives and plywood adhesives, primers, coatings for concrete and mineral-bonded surfaces, self-leveling floor screeds, powder paints and/or smoothing and/or troweling compounds.

Preferred applications are polymer-modified dry building material compositions which are liquid-applied, wherein the term liquid includes pasty consistency, and which lead to water-impermeable products, essentially free of mineral binders, i.e. which contain less than 5 wt. % mineral binders such as cement, gypsum, hydrated lime, latent hydraulic and/or pozzolanic compounds. The water-impermeable products can be used e.g. beneath ceramic tiles for internal and external tile installations on walls and floors.

Preferred also are dry building material compositions formulated as powder paints, ceramic tile adhesive (CTA), grouts, and external thermal insulation composite systems (ETICS). Such building material compositions may be based on cement, on gypsum, or they may be essentially free of a mineral binder.

In one preferred embodiment, the building material composition of the invention is in the form of a dry uncured composition. It may contain 5-90 wt. %, preferably 15-80 wt. %, and in particular 30-75 wt. %, of the water-redispersible polymer powder of the invention, 0-5 wt. % of mineral binder which preferably includes calcium hydroxide, cement, gypsum and/or pozzolanic compounds, 10-90 wt. %, preferably 20-80 wt. %, and in particular 25-70 wt. %, of mineral fillers, 0-10 wt. %, preferably 0.1-5 wt. %, of thickeners, 0-5 wt. % defoamers, in particular powder defoamers, 0-2 wt. % wetting agents, 0-2 wt. % polysaccharide ether, e.g. cellulose ether and/or guar ether, 0-2 wt. % superplasticizer and/or 0-5 wt. % further adjuvants, wherein the ingredients sum up to 100 wt. % of the total dry building material composition formulation.

In another embodiment, the building material composition is based on a known cement-based or gypsum-based formulation and further contains the polymerizate of the invention in the form of an aqueous dispersion and/or polymer powder.

Suitable mineral fillers, also known under the term aggregates, include quartzitic and/or carbonatic sands and/or powders such as for instance quartz sand and/or limestone powder, carbonates, silicates, chalks, layered silicates, precipitated silica, light-weight fillers such as for instance hollow microspheres of glass, alumosilicates, silica, aluminium-silica, calcium-silicate hydrate, silicon dioxide, aluminium-silicate, magnesium-silicate, aluminium-silicate hydrate, calcium-aluminium-silicate, calcium-silicate hydrate, calcium-metasilicate, aluminium-iron-magnesium-silicate, clays such as bentonite and/or volcanic slag, as well as pozzolanes such as metakaolin and/or latently hydraulic components, in which case the fillers and/or light-weight fillers can also have a natural or artificially generated colour.

Furthermore, besides the water-redispersible polymer powder, the composition may also contain “the other part” of the kit of parts as described above, which may be added as a separate compound.

The building material composition of the invention, when mixed with water, can be applied basically on any substrate suitable to be covered with a building material composition. Non-limiting examples of such substrates are concrete, self-leveling compounds, screeds, gypsum board, plasters, gypsum or cement-based putties, bricks, wood, cement fiberboards, ceramic tiles, expanded polystyrene and/or skim coats.

The invention is further elucidated with reference to the following examples. Unless indicated otherwise, the tests are carried out at a temperature of 23° C. and a relative humidity of 50%.

### EXAMPLES

The following monomers were used as macromonomer M:
CN966H90: Difunctional aliphatic polyester urethane acrylate oligomer, diluted with 10 wt. % of 2-(2-ethoxyethoxy)ethyl acrylate having a viscosity at 50° C. of 16-31 Pas and a number average molecular weight of about 1,000. Supplier: Sartomer.
CN9002: Difunctional aliphatic urethane acrylate having a viscosity at 60° C. of 2,000-4000 mPa·s and a number average molecular weight of about 12,150. Supplier: Sartomer.

### Synthesis of Dispersions and Powders

### Example 1

### Preparation of Dispersion D1

49.14 g of polyvinyl alcohol (PVA) having a hydrolysis degree of 88% and a Höppler viscosity of 4 mPa·s (in the form of a 4% aqueous solution) and 2.4 g sodium acetate dissolved in 340.93 g water were placed in a 3-liter glass reactor equipped with a stirrer and a temperature control device. The reactor was heated to 78° C. under stirring. In parallel, a monomer emulsion was prepared in a separate flask under stirring. Preparation of the monomer emulsion: To 16.38 g of polyvinyl alcohol having a hydrolysis degree of 88% and a Höppler viscosity of 4 mPa·s (in the form of a 4% aqueous solution) dissolved in 633.15 g water a mixture of 609.6 g butyl acrylate, 482.88 g methyl methacrylate, 10.92 g CN966H90, 2.74 g n-dodecyl mercaptan was added under stirring. 5% by weight of the monomer emulsion prepared was added quickly to the glass reactor, followed by the addition of 0.37 g ammonium persulfate dissolved in 32.0 g water. After a further initial polymerization time of 10 minutes 95% by weight of the monomer emulsion was added over a period of 4 hours and in parallel 1.30 g ammonium persulfate (APS) dissolved in 112.0 g water was fed in over a period of 5 hours. After the addition of the APS solution was complete, 0.19 g of ammonium persulfate dissolved in 16.0 g was added quickly. The mixture was then maintained at a temperature of 78° C. for a further 60 minutes. After cooling down to 60° C., 1.09 g of t-butyl hydroperoxide dissolved in 20.47 g water was added quickly. 5 minutes later 1.09 g sodium formaldehyde sulfoxylate dissolved in 20.0 g water was fed in over a period of 30 minutes. The mixture was then maintained at a temperature of 60° C. for a further 60 minutes, followed by cooling down to room temperature. The obtained stable dispersion was analyzed to give a solid content of 50.0 wt. %, a pH of 4.7, a Brookfield viscosity (spindle 4 measured at 20 rpm and 23° C.) of 5,870 mPa·s, a glass transition temperature (midpoint) of +8° C., a mean particle size distribution (Mastersizer, polydisperse model) of d_{w}=0.38 μm with d_{w}/dₙ=3.3, a minimum film formation temperature (MFFT) of 0° C., and a content of volatile organic compounds (VOC) of below 1,000 ppm.

### Example 2

### Preparation of Dispersion D2

49.14 g of polyvinyl alcohol (PVA) having a hydrolysis degree of 88% and a Höppler viscosity of 4 mPa·s (in the form of a 4% aqueous solution) and 2.4 g sodium acetate dissolved in 340.93 g water were placed in a 3-liter glass reactor equipped with a stirrer and a temperature control device. The reactor was heated to 78° C. under stirring. In parallel two monomer emulsions (I and II) were prepared in two separate flasks under stirring. Preparation of monomer emulsion (I): To 0.82 g of polyvinyl alcohol having a hydrolysis degree of 88% and a Floppier viscosity of 4 mPa·s (in the form of a 4% aqueous solution) dissolved in 31.66 g water a mixture of 30.48 g butyl acrylate, 24.14 g methyl methacrylate, 10.92 g CN966H90, 0.137 g n-dodecyl mercaptan was added under stirring. Preparation of monomer emulsion (II): To 15.56 g of polyvinyl alcohol having a hydrolysis degree of 88% and a Floppier viscosity of 4 mPa·s (in the form of a 4% aqueous solution) dissolved in 601.49 g water a mixture of 579.12 g butyl acrylate, 458.74 g methyl methacrylate, 2.603 g n-dodecyl mercaptan was added under stirring. Monomer emulsion (I) was added quickly to the glass reactor, followed by the addition of 0.37 g ammonium persulfate dissolved in 32.0 g water. After a further initial polymerization time of 10 minutes monomer emulsion (II) was added over a period of 4 hours and in parallel 1.30 g ammonium persulfate (APS) dissolved in 112.0 g water was fed in over a period of 5 hours. After the addition of the APS solution was complete, 0.19 g of ammonium persulfate dissolved in 16.0 g was added quickly. The mixture was then maintained at a temperature of 78° C. for a further 60 minutes. After cooling down to 60° C., 1.09 g of t-butyl hydroperoxide dissolved in 20.47 g water was added quickly. 5 minutes later 1.09 g sodium formaldehyde sulfoxylate dissolved in 20.0 g water was fed in over a period of 30 minutes. The mixture was then maintained at a temperature of 60° C. for a further 60 minutes, followed by cooling down to room temperature. The obtained stable dispersion was analyzed to give a solid content of 50.0 wt. % a pH of 4.8, a Brookfield viscosity (spindle 4 measured at 20 rpm and 23° C.) of 5,240 mPa·s, a glass transition temperature (midpoint) of 9° C., and a mean particle size distribution (Mastersizer, polydisperse model) d_{w}=0.77 μm; d_{w}/dₙ=7.7, a minimum film formation temperature (MFFT) of 0° C., and a content of volatile organic compounds (VOC) of below 1,000 ppm.

### Example 3

### Preparation of Dispersion D3

49.14 g of polyvinyl alcohol (PVA) having a hydrolysis degree of 88% and a Höppler viscosity of 4 mPa·s (in the form of a 4% aqueous solution) and 2.4 g sodium acetate dissolved in 340.93 g water were placed in a 3-liter glass reactor equipped with a stirrer and a temperature control device. The reactor was heated to 78° C. under stirring. In parallel a monomer emulsion was prepared in a separate flask under stirring. Preparation of the monomer emulsion: To 16.38 g of polyvinyl alcohol having a hydrolysis degree of 88% and a Höppler viscosity of 4 mPa·s (in the form of a 4% aqueous solution) dissolved in 633.15 g water a mixture of 709.72 g butyl acrylate, 382.16 g methyl methacrylate, 10.92 g CN9002, 3.27 g n-dodecyl mercaptan was added under stirring. 5% by weight of the monomer emulsion prepared was added quickly to the glass reactor, followed by the addition of 0.37 g ammonium persulfate dissolved in 32.0 g water. After a further initial polymerization time of 10 minutes, 95% by weight of the monomer emulsion was added over a period of 4 hours and in parallel 1.30 g ammonium persulfate (APS) dissolved in 112.0 g water was fed in over a period of 5 hours. After the addition of the APS solution was complete, 0.19 g of ammonium persulfate dissolved in 16.0 g was added quickly. The mixture was then maintained at a temperature of 78° C. for a further 60 minutes. After cooling down to 60° C., 1.09 g of t-butyl hydroperoxide dissolved in 20.47 g water was added quickly. 5 minutes later 1.09 g sodium formaldehyde sulfoxylate dissolved in 20.0 g water was fed in over a period of 30 minutes. The mixture was then maintained at a temperature of 60° C. for a further 60 minutes, followed by cooling down to room temperature. The obtained stable dispersion was analyzed to give a solid content of 50.1%, a pH of 4.7, a Brookfield viscosity (spindle 4 measured at 20 rpm and 23° C.) of 4,780 mPa·s, a glass transition temperature (midpoint) of −4° C., and a mean particle size distribution (Mastersizer, polydisperse model) of d_{w}=0.39 μm; d_{w}/dₙ=3.63, a minimum film formation temperature (MFFT) of 0° C., and a content of volatile organic compounds (VOC) of below 1,000 ppm.

### Example 4

### Preparation of Dispersion D4

49.14 g of polyvinyl alcohol (PVA) having a hydrolysis degree of 88% and a Höppler viscosity of 4 mPa·s (in the form of a 4% aqueous solution) and 2.4 g sodium acetate dissolved in 340.93 g water were placed in a 3-liter glass reactor equipped with a stirrer and a temperature control device. The reactor was heated to 78° C. under stirring. In parallel two monomer emulsions (I and II) were prepared in two separate flasks under stirring. Preparation of monomer emulsion (I): To 0.82 g of polyvinyl alcohol having a hydrolysis degree of 88% and a Höppler viscosity of 4 mPa·s (in the form of a 4% aqueous solution) dissolved in 31.66 g water a mixture of 35.49 g butyl acrylate, 19.11 g methyl methacrylate, 10.92 g CN9002, 0.164 g n-dodecyl mercaptan were added under stirring. Preparation of monomer emulsion (II): To 15.56 g of polyvinyl alcohol having a hydrolysis degree of 88% and a viscosity of 4 mPa·s (in the form of a 4% aqueous solution) dissolved in 601.49 g water a mixture of 674.23 g butyl acrylate, 363.05 g methyl methacrylate, 3.106 g n-dodecyl mercaptan was added under stirring. Monomer emulsion (I) was added quickly to the glass reactor, followed by the addition of 0.37 g ammonium persulfate dissolved in 32.0 g water. After a further initial polymerization time of 10 minutes, monomer emulsion (II) was added over a period of 4 hours and in parallel 1.30 g ammonium persulfate (APS) dissolved in 112.0 g water was fed in over a period of 5 hours. After the addition of the APS solution was complete, 0.19 g of ammonium persulfate dissolved in 16.0 g was added quickly. The mixture was then maintained at a temperature of 78° C. for a further 60 minutes. After cooling down to 60° C., 1.09 g of t-butyl hydroperoxide dissolved in 20.47 g water was added quickly. 5 minutes later 1.09 g sodium formaldehyde sulfoxylate dissolved in 20.0 g water was fed in over a period of 30 minutes. The mixture was then maintained at a temperature of 60° C. for a further 60 minutes, followed by cooling down to room temperature. The obtained stable dispersion was analyzed to give a solid content of 50.0 wt. %, a pH of 4.7, a Brookfield viscosity (spindle 4 measured at 20 rpm and 23° C.) of 5,350 mPa·s, a glass transition temperature (midpoint) of −5° C., and a mean particle size distribution (Mastersizer, polydisperse model) of d_{w}=0.46 μm; d_{w}/dₙ=3.97, a minimum film formation temperature (MFFT) of 0° C., and a content of volatile organic compounds (VOC) of below 1,000 ppm.

### Example 5

### Preparation of Dispersion D5

54.60 g of polyvinyl alcohol (PVA) having a hydrolysis degree of 99% and a Höppler viscosity of 3 mPa·s (in the form of a 4% aqueous solution) and 2.0 g sodium acetate dissolved in 678.4 g water were placed in a 3-liter glass reactor equipped with a stirrer and a temperature control device. The reactor was heated to 78° C. under stirring. 2.28 g of n-dodecyl mercaptan were added quickly. A monomer mixture consisting of 25.4 g butyl acrylate, 20.12 g methyl methacrylate, and 4.55 g CN9002 was added quickly to the glass reactor, followed by the addition of 0.31 g ammonium persulfate dissolved in 40.0 g water. After a further initial polymerization time of 10 minutes, a monomer mixture consisting of 482.6 g butyl acrylate and 382.28 g methyl methacrylate was fed in over a period of 4 hours and in parallel 1.085 g ammonium persulfate (APS) dissolved in 140.0 g water was added over a period of 5 hours. After the addition of the APS solution was complete, 0.155 g of ammonium persulfate dissolved in 20.0 g was added quickly. The mixture was then maintained at a temperature of 78° C. for a further 60 minutes. After cooling down to 60° C., 0.91 g of t-butyl hydroperoxide dissolved in 50.39 g water was added quickly. 5 minutes later 0.91 g sodium formaldehyde sulfoxylate dissolved in 50.0 g water was fed in over a period of 30 minutes. The mixture was then maintained at a temperature of 60° C. for a further 60 minutes, followed by cooling down to room temperature. The obtained stable dispersion was analyzed to give a solid content of 49.9 wt. %, a pH of 4.6, a Brookfield viscosity (spindle 1 measured at 20 rpm and 23° C.) of 240 mPa·s, a glass transition temperature (midpoint) of +6° C., and a mean particle size distribution (Mastersizer, polydisperse model) of d_{w}=0.34 μm; d_{w}/dₙ=1.85, a minimum film-formation temperature (MFFT) of 0° C., and a content of volatile organic compounds (VOC) of below 1,000 ppm.

### Example 6

### Preparation of Dispersion D6

54.60 g of polyvinyl alcohol (PVA) having a hydrolysis degree of 99% and a Höppler viscosity of 3 mPa·s (in the form of a 4% aqueous solution) and 2.0 g sodium acetate dissolved in 678.4 g water were placed in a 3-liter glass reactor equipped with a stirrer and a temperature control device. The reactor was heated to 78° C. under stirring. 2.28 g of n-dodecyl mercaptan were added quickly. A monomer mixture consisting of 25.4 g butyl acrylate, 20.12 g methyl methacrylate, and 4.55 g CN966H90 was added quickly to the glass reactor, followed by the addition of 0.31 g ammonium persulfate dissolved in 40.0 g water. After a further initial polymerization time of 10 minutes a monomer mixture consisting of 482.6 g butyl acrylate and 382.28 g methyl methacrylate was fed in over a period of 4 hours and in parallel 1.085 g ammonium persulfate (APS) dissolved in 140.0 g water was added over a period of 5 hours. After the addition of the APS solution was complete, 0.155 g of ammonium persulfate dissolved in 20.0 g was added quickly. The mixture was then maintained at a temperature of 78° C. for a further 60 minutes. After cooling down to 60° C., 0.91 g of t-butyl hydroperoxide dissolved in 50.39 g water was added quickly. 5 minutes later 0.91 g sodium formaldehyde sulfoxylate dissolved in 50.0 g water was fed in over a period of 30 minutes. The mixture was then maintained at a temperature of 60° C. for a further 60 minutes, followed by cooling down to room temperature. The obtained stable dispersion was analyzed to give a solid content of 49.9%, a pH of 4.6, a Brookfield viscosity (spindle 1 measured at 20 rpm at 23° C.) of 230 mPa·s, a glass transition temperature (midpoint) of +3° C., and a mean particle size distribution (Mastersizer, polydisperse model) of d_{w}=0.36 μm; d_{w}/dₙ=1.84, a minimum film formation temperature (MFFT) of 0° C., and a content of volatile organic compounds (VOC) of below 1,000 ppm.

### Example 7

### Preparation of Comparative Dispersion C1

Example 1 was repeated, except that no macromonomer CN966H90 was added. It resulted a dispersion with a solids content of 49.8 wt. %, a pH of 4.9, a Brookfield viscosity (spindle 5 measured at 20 rpm at 23° C.) of 6,080 mPa·s, a glass transition temperature (midpoint) of +7° C., and a mean particle size distribution (Mastersizer, polydisperse model) of d_{w}=0.32 μm; d_{w}/dₙ=3.21, a minimum film formation temperature (MFFT) of 0° C., and a content of volatile organic compounds (VOC) of below 1,000 ppm.

### Example 8

### Spray Drying of Dispersions

Polymer powders were prepared via spray drying the dispersions D1 to D6 and C1 (from Examples 1 to 7), in the presence of 10 wt. % in each case of a polyvinyl alcohol having a Höppler viscosity of 4 mPa·s (in the form of a 4% aqueous solution) and a degree of hydrolysis of about 88 mol %. Spraying of the dispersions was done by means of a two-fluid nozzle and by using 19 wt. % of a commercially available anti-caking agent (dolomite). All amounts are in relation to the solids of the additions and sum up to 100 wt. %. The mixtures were spray dried without further additives through conventional spray drying with an inlet temperature of 130° C. and an outlet temperature of 65° C. to white, free flowing polymer powders P1 to P6 and P-C1 with good yield. The obtained powders are block stable and they showed an excellent wettability and redispersibility upon contact with water.

### Application Tests

### Example 9

### Preparation of Dry Compositions, Formulated as Cement-Free Membranes

135.8 g of each polymer powder from Example 8, 57.8 g of a commercially available calcium carbonate (OmyaCarb 5GU from Omya, Switzerland), 4.0 g of calcium hydroxide, 0.4 g of a commercially available superplasticizer (Melment F10 from BASF, Germany), and 2.0 g of a powder defoamer (Agitan P843 from Münzing Chemie, Germany) were mixed with a lab mixer until a homogeneous dry building material composition was obtained.

### Example 10

### Preparation of Cement-Free Membrane Films

To the dry building material compositions from Example 960 g of tap water were added to give the fresh compositions suitable workability properties. Each of the obtained mixtures was mixed by hand with a metal spatula for 1 minute, followed by further mixing with a Vollrath EWTHV 0.5 stirrer with a Lenart-Disc of 65 mm Diameter (Fa. Vollrath, D-Hürth) at 1,820 rpm for 5 minutes. Afterwards, the composition was poured into a steel template, which was placed onto a polyethylene foil on an even surface. The template had an opening of 10 cm×20 cm and a thickness of 2 mm. The specimens were allowed to dry at standard conditions (23° C. and 50% relative humidity) for 24 hrs. Afterwards, the obtained films were removed and further stored for 6 days at standard conditions on a lattice. The specimens were turned every day to ensure even drying of all surfaces.

### Example 11

### Tensile Strength and Elongation Measurements

After the drying period as disclosed in Example 10, 6 specimens of 15 mm width and 95-100 mm length were cut off. The specimens did not show any signs of visible damages like cracks, holes or encapsulated air bubbles. Three cut off specimens were measured immediately to determine the properties after dry storage. The other three cut off specimens were immersed in tap water for 3 days. To this end bowls with glass pearls at the bottom are prepared to allow easy water contact also on the bottom of the specimens. Immediately before testing, the mean value of thickness for each single specimen was determined. The specimens were then fixed in a ZWICK Z100 Universal testing machine with a pneumatic holder device to ensure a starting length of 50 mm. The test runs were carried out at a constant elongation speed of 10 mm/minute until break and the data were monitored continuously to deliver stress/elongation graphs.

The mechanical properties of the membranes, recorded as tensile strength at maximum force in N/mm² and as elongation at maximum force in %, were computed as mean values of 3 single measurements, after dry and wet storage, respectively.

TABLE 1
Tensile strength and elongation at maximum force of cement-free
membrane formulations after dry and wet storage.

| | | Dry storage | | Wet storage | |
|---|---|---|---|---|---|
| | | Tensile | Elongation | Tensile | Elongation |
| Powder | Dispersion | strength | @ Fₘₐₓ | strength | @ Fₘₐₓ |
| No. | No. | [N/mm²] | [%] | [N/mm²] | [%] |
| P1 | D1 | 2.49 | 187 | 0.70 | 681 |
| P2 | D2 | 3.03 | 225 | 0.77 | 730 |
| P-C1 | C1 | 3.81 | 143 | 0.42 | 619 |

As follows from Table 1, the tensile strength of the cement-free membrane formulations decreases during wet storage. While the tensile strength after wet storage is 28% and 25.4% for the membranes containing P1 and P2, respectively, it is only 11% for the membrane containing the comparison powder P-C1. Additionally, the tensile strength after wet storage of the building material compositions of the invention, i.e. those containing the powders P1 and P2, respectively, is 67% (with P1) and 83% (with P2) higher than for the one containing the comparison powder P-C1.

Additionally, the data from Table 1 further demonstrate that the Elongation at maximum force of the membranes after dry storage is 31% (with P1) and 57% (with P2) higher than the one for the membranes containing the comparison powder P-C1. It is noted that the elongation after dry storage is more important than after wet storage, since the values are lower and thus more critical.

It is noted that with the polymerizate of the invention, in the form of the aqueous dispersion or of the water-redispersible polymer powder, building material compositions can be formulated which can meet the requirements of ETAG022, Part 1. Hence, it is therefore possible to formulate dry building material compositions in uncured form which meet these requirements when mixed with water, applied, and cured.

The polymerizate of the invention further provides building material compositions—irrespective of whether they are cement-, gypsum- or polymer-based—with advantageous fresh mortar properties such as excellent wettability and miscibility upon contact with water, excellent rheological characteristics, including a good workability of the compositions, when mixed with water.

1. Polymerizate in the form of an aqueous polymer dispersion, the polymerizate being obtainable by radical polymerization of monomers in an aqueous medium in the presence of a free radical initiator and a protective colloid, wherein the monomers comprise
a) 50-99.99 wt. % of at least one vinyl monomer chosen from the group of vinyl esters, (meth)acrylic esters, vinyl aromatic compounds, vinyl halides, and olefins,
b) 0.01-30 wt. % of at least one macromonomer M, the macromonomer M being a reaction product of components (i), (ii), and (iii), said
component (i) having at least one olefinically unsaturated group and at least one hydroxyl, amine and/or thiol group,
component (ii) being a di- or triisocyanate, and
component (iii) having at least two terminal groups selected from hydroxyl, amine and/or thiol groups, and
c) 0-20 wt. % of at least one vinyl monomer with at least one functional group selected from the group of alkoxysilane, silanol, glycidyl, epoxy, epihalohydrin, nitrile, carboxyl, amine, ammonium, amide, imide, N-methylol, isocyanate, hydroxyl, thiol, keto, carbonyl, carboxylic anhydride, sulfonic acid groups, and salts thereof, and monomers having one or more further vinyl groups,
wherein the monomers a), b) and c) sum up to 100 wt. % of total monomers employed.

2. The polymerizate of claim 1 wherein
component (i) is a vinyl monomer containing a hydroxyl, amino and/or thiol group,
component (ii) is a diisocyanate, and
component (iii) is a diol, diamine, dithiol, polyol, polyamine, polythiol, polyhydroxy polyolefin, polyester, polyether, polycarbonate, polyamide or a polyalkylene oxide having terminal hydroxyl, amine and/or thiol groups, said alkylene group being an ethylene, propylene or butylene group.

3. The polymerizate of claim 1, wherein at least 50 wt. % of the macromonomer M has the formula (I)
A-B-(C-B-)ₓA (I)
wherein A originates from component (i), B originates from component (ii), and C originates from component (iii), and A and C are linked with B through a urethane, urea and/or a thiourea group, and x is an integer of 1 to 200.

4. A water-redispersible polymer powder obtained by drying the polymerizate of claim 1.

5. A process of making the polymerizate of claim 1 by means of emulsion or suspension polymerization in a polymerization reactor.

6. The process of claim 5 wherein at least 50 wt. % of the macromonomer M, based on the total amount of macromonomer M employed, is
mixed with the vinyl monomers a) and c) to form a monomer blend and is added as such to the reactor, or
mixed with the vinyl monomers a) and c), water, and the water-soluble polymer to form a preemulsion, wherein said preemulsion is added to the reactor,
wherein the blend and/or the preemulsion are added before the start of the polymerization and/or during the polymerization.

7. (canceled)

8. (canceled)

9. A building material composition containing the polymerizate of claim 1 and/or a water-redispersible polymer powder obtained by drying said polymerizate, and at least one mineral binder or filler.

10. The building material composition of claim 9 that is in the form of a dry uncured composition.

11. The building material composition of claim 9 wherein the building material composition contains no or less than 5 wt. % of cement and/or gypsum.

12. The building material composition of claim 9, wherein said composition is formulated as coating or composite material useful for thermal insulation, sealing applications, flexible water-proofing membranes, plasters, renders, repair mortar, tile grouts, adhesives, ceramic tile adhesives, parquet adhesives, plywood adhesives, primers, coatings for concrete and mineral-bonded surfaces, self-leveling floor screeds, powder paints and/or smoothing and/or troweling compounds.

13. A kit of parts suitable for use in building applications, one part being the water-redispersible polymer powder of claim 4 and the other part being one or more powdery additives selected from the group of hydrophobic and/or oleophobic additives, rheology control additives, thickeners, polysaccharides and derivatives thereof, additives to control the hydration and/or setting, surface-active additives, pigments, fibers, film coalescing agents and plasticizers, corrosion protection additives, pH-adjusting additives, additives for the reduction of shrinkage and/or efflorescence.

14. The polymerizate of claim 2, wherein at least 50 wt. % of the macromonomer M has the formula (I)
A-B-(C-B-)ₓA (I)
wherein A originates from component (i), B originates from component (ii), and C originates from component (iii), and A and C are linked with B through a urethane, urea and/or a thiourea group, and x is an integer of 1 to 200.
